(19) United States
(12) Patent Application Publication
(10) Pub. No.: US 2006/0127549 A1
(43) Pub. Date: Jun. 15, 2006

(54) Heatable package with frangible seal and method of manufacture

(76) Inventor: R. Charles Murray, Sarasota, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/329,712

(22) Filed: Jan. 11, 2006

Related U.S. Application Data
(63) Continuation-in-part of application No. 10/228,430, filed on Aug. 27, 2002.
(60) Provisional application No. 60/315,207, filed on Aug. 27, 2001.
(60) Provisional application No. 60/679,054, filed on May 9, 2005.

(51) Int. Cl. A23B 4/06

(52) U.S. Cl. 426/393

(57) ABSTRACT

A flexible pouch having an integral valve for both packaging a product and serving the product and a method of making the same is provided. The flexible pouch includes a panel having an upper edge, an opposed lower edge, and a side edge extending therebetween the upper and lower edges. The flexible pouch further includes a valve disposed in the panel, wherein the valve is a one-way valve for releasing a gas from the pouch at a predetermined gas release pressure. A frangible seal encloses the valve to isolate the valve from the product contained in the flexible pouch, such that the frangible seal is intact when the pressure within the flexible pouch is less than a predetermined frangible seal pressure, and the frangible seal is broken when the pressure within the flexible pouch is greater than the predetermined frangible seal bursting pressure. The method includes the steps of forming the pouch, and inserting a valve in the panel. The method also includes the steps of enclosing the valve with a frangible seal and sealing the edges of the pouch, leaving an upper edge open. The method still also includes the steps of opening, filling and sealing the filled pouch. The method further includes the steps of increasing the pressure in the pouch until the pressure exceeds the predetermined frangible seal bursting pressure and the frangible seal breaks, to release the gas from the pouch.

### RELATED APPLICATIONS

This application is a continuation-in-part of U.S. patent application Ser. No. 10/228,430 filed Aug. 27, 2002, which claims priority of U.S. Provisional Patent Application Ser. No. 60/315,207 filed Aug. 27, 2001. This application also claims priority from U.S. Provisional Application Ser. No. 60/679,054 filed May 9, 2005. Both are incorporated herein by reference.

### FIELD OF THE INVENTION

The present invention relates generally to a package for both storing and cooking a food product contained therein, and more particularly to a heatable package having a frangible seal surrounding a valve, and a method of manufacturing and filling the package.

### BACKGROUND OF THE INVENTION

Various types of disposable, portable containers are known in the art for storing a fluid or dry product, such as a liquid, granular material, powder or the like. One example of such a container is a flexible pouch. Consumers prefer the convenience of flexible pouches, due to their shape, size and shelf life. Flexible pouches have been used for some time to distribute beverages, such as fruit juice and the like. More recently, flexible pouches have been utilized for solid food products.

At the same time, various types of disposable containers have been developed for use in heating or cooking foods in an oven, including a conventional electric or gas oven, a convection oven or a microwave oven. A common feature of the disposable container is a venting means, which provides for the release of steam or any other gas that may be generated within the package. The flexible pouch may be used as a disposable container for both storing and cooking the food product contained therein. Advantageously, the flexible pouch may be used in cooking a frozen food, or a food at room temperature.

Manufacturers recognize the packaging benefits of a flexible pouch due to its versatility. For instance, the pouch can be formed and filled on the same manufacturing line. An example of a method and apparatus for filling a flexible pouch with a product is disclosed in commonly assigned U.S. Pat. No. 6,199,601, which is likewise incorporated herein by reference.

The flexible pouch is preferably made from a flexible material, such as a laminate composed of sheets of plastic or aluminum or the like. In this example, the material is available in sheet form, on a roll. An outer layer of the material may include preprinted information, such as a logo or the like, to provide the consumer with information regarding the contents of the pouch. The pouch may be formed using conventionally known manufacturing techniques, such as a horizontal form-fill seal machine, a flat bed pre-made pouch machine, a vertical form-fill machine, or the like. The pouch is generally formed by a folding sheet of material to achieve a predetermined shape. Edges, such as a side edge, may be joined together using a sealing technique such as bonding or welding. The pouch may also include a gusset inserted between two parallel edges, to form a pouch capable of standing unsupported. An upper edge of the panel is generally not sealed until after the pouch is filled. The empty pouch may be placed in a holder such as a cup or puck prior to the filling process. To fill the pouch, the upper edges of the pouch are first spread apart. For example, a concentrated flow of gas is directed towards the upper edge of the pouch to separate the panels. Grippers may also be utilized at the same time to pull the panels apart. The open pouch is filled, sealed and finished as required.

While the above described flexible pouch works well for storing and heating the food product contained therein, the potential exists that contact between the product and the valve may disrupt the hermetic seal of the valve. Thus, there is a need in the art for a flexible pouch with an integral valve that is leak proof, and an improved method of making such a flexible pouch, that can be used to both store various types of products and to cook the product contained within the package.

### SUMMARY OF THE INVENTION

Accordingly, a flexible pouch having an integral valve for both packaging a product and serving the product and a method of making the same is provided. The flexible pouch includes a panel having an upper edge, an opposed lower edge, and a side edge extending therebetween the upper and lower edges. The flexible pouch further includes a valve disposed in the panel, wherein the valve is a one-way valve for releasing a gas from the pouch at a predetermined gas release pressure. The pouch further includes a frangible seal enclosing the valve to isolate the valve from the product contained in the flexible pouch. The frangible seal is intact when the pressure within the flexible pouch is less than a predetermined frangible seal bursting pressure, and the frangible seal is broken when the pressure within the flexible pouch is greater than the predetermined frangible seal bursting pressure to release the gas from the pouch through the valve. The method includes the steps of forming the pouch, and inserting a valve in the front panel. The method also includes the steps of enclosing the valve with a frangible seal and sealing the edges of the pouch, leaving an upper edge open. The method still also includes the steps of opening, filling and sealing the filled pouch. The method further includes the steps of increasing the pressure in the pouch until the pressure exceeds the predetermined frangible seal bursting pressure and the frangible seal breaks, to release the gas from the pouch.

One advantage of the present invention is that a flexible pouch and an improved method of making and filling a flexible pouch with a product is provided, and the flexible pouch is suitable for both storing and heating of the product contained therein. Another advantage of the present invention is that a flexible pouch and method of making the same is provided that encloses a valve portion of the flexible pouch with a frangible seal. Still another advantage of the present invention is that a flexible pouch and method of making the same is provided that retains the hermetic seal characteristics of the valve, to prevent leakage of the product through the valve. A further advantage of the present invention is that a flexible pouch and a method of making the same are provided that is cost effective to manufacture. Yet a further advantage of the present invention is that the flexible pouch can be placed unopened in a microwave oven in order to heat the contents of the pouch. Yet still a further advantage of the present invention is that the flexible pouch can be frozen, and then placed unopened in a microwave oven in order to heat the contents of the pouch. Still another advantage of the present invention is that the package may include a breathable film to enhance product quality.

### BRIEF DESCRIPTION OF THE DRAWINGS

FIG. 1 is a front view of a flexible pouch with a frangible seal, according to the present invention.

FIG. 2 is a cross-sectional view of the flexible pouch of FIG. 1, according to the present invention.

FIG. 3 is a front view of the flexible pouch of FIG. 1 partially separated along the line of weakening, according to the present invention.

FIG. 4 is a perspective view of the flexible pouch of FIG. 1, after the top portion has been removed, according to the present invention.

FIG. 5 is a front view of another example of the flexible pouch, according to the present invention.

FIG. 6 is a front view of the flexible pouch of FIG. 5, according to the present invention.

FIG. 7 is a perspective view of another embodiment of a package according to the present invention.

FIG. 8 is a flowchart illustrating a method of using the flexible pouch, according to the present invention.

FIG. 9 is a perspective view of another example of a flexible pouch, according to the present invention.

FIG. 10 is a perspective view of yet another example of a flexible pouch that includes a breathable patch, according to the present invention.

FIG. 11 is a flowchart illustrating a method of manufacturing and filling the flexible pouch, according to the present invention.

### DETAILED DESCRIPTION OF THE PREFERRED EMBODIMENTS

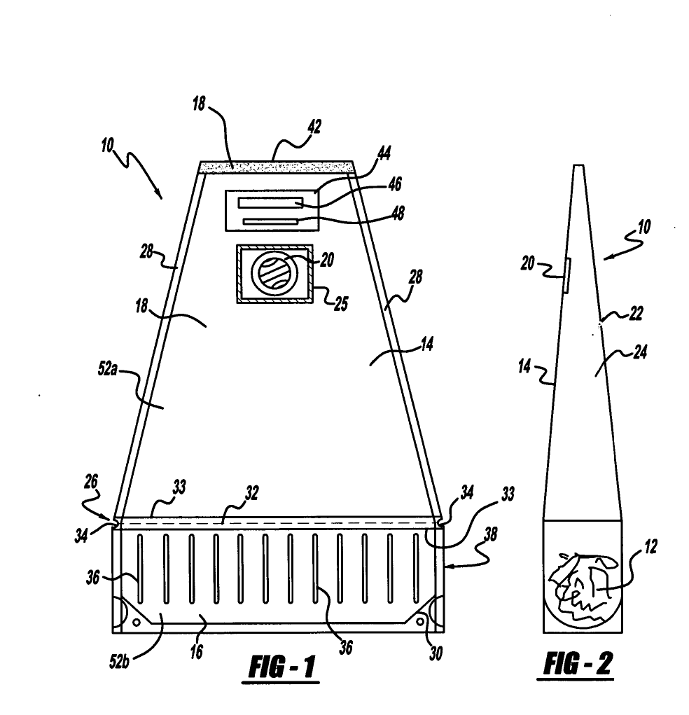

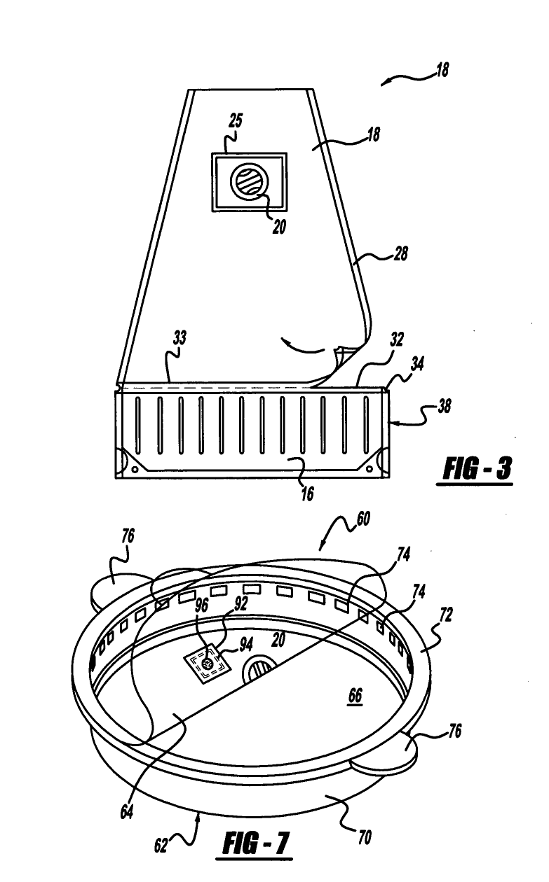

Referring to FIGS. 1-4 and 9-10, a sealed, flexible pouch 10 is illustrated. The pouch 10 is filled with a product (not shown) and sealed. The type of product is unlimited, and could have a solid or a liquid form. The product is preferably a food item and the pouch may contain a single serving, or multiple servings, of the food product. In this example, the pouch 10 is a flexible stand-up pouch suitable for heating a precooked food portion 12 in an oven, such as a microwave oven, or convection oven or the like.

The flexible pouch 10 is preferably formed from a roll of flexible, preprinted laminate material. The choice of laminate material is nonlimiting, and is influenced by factors such as the product contained in the pouch 10, the shape of the pouch or the anticipated use of the pouch. The laminate is typically a three or four or five gauge material. The outer layer is usually preprinted. For example, the laminate material may include at least one layer of virgin polyethylene terphalate (PET) and at least one layer of aluminum foil (AL) and another layer such as EVOH, PET, polyethylene, or polypropylene or nylon or the like. Alternatively, the laminate may include a metalized foil paper layer laminated to a cast polypropylene layer and another layer of PET, polyethylene or EVOH. Another material example includes a cast polypropylene (CPP) layer, a polyethylene (PET) layer, a foil (AL) layer, a nylon (ONO) layer and another CPP layer. Another example of a material structure is the use of nylon, foil, nylon, and cast polypropylene (ONO/AL/ONO/CPP) or CPP/NY/AL/CPP. A further example of a laminate material structure is CPP/AL/ONO/PE. This structure works well when the product has a short shelf life, and the nylon eliminates stretching or cracking of the AL layer. Advantageously, a pouch 10 made using the cast polypropylene laminate material retains its filled shape even as the product is removed from the pouch 10. It should be appreciated that a portion of the material may be a clear laminate, in order to view the contents of the pouch.

The pouch 10 may be formed from a sheet of material or panel that is folded so that the outer edges are joined together to form one center seam. Alternatively, the pouch may be formed from two facing panels of material that are joined together along corresponding side edges.

The pouch 10 includes a front wall 14 and a rear wall 22. In this example, the pouch 10 has a generally rectangular shape, although other shapes are contemplated. Further, the pouch is defined by an upper edge 18, an opposed lower edge 16, and at least one side edge 28 extending therebetween the upper and lower edges 16, 18.

The pouch 10 may include a sidewall 24 disposed between the front and back walls. The sidewall advantageously allows the pouch 10 to acquire another shape, such as cylindrical, or to stand upright. For example, the sidewall 24 may be formed as a gusset, pleat or an insert. The gusset may be generally wider at the lower edge and taper upwardly towards the upper edge, or be of a uniform dimension. The sidewall 24 may be integrally formed in the panel or a separate piece of material. Alternatively, the sidewall may be formed at the lower edges of the pouch 10 to provide a base for the pouch 10 to stand upright.

The pouch may include a plurality of vertically oriented ribs 36. The ribs provide rigidity to the panel. In this example, the ribs are thermoformed into the wall of the lower compartment of the pouch, so that the lower compartment forms a tray 38 with sides 40 for serving the product after the upper compartment is removed.

The pouch includes an integral valve 20. The valve 20 is preferably positioned in an upper portion of one wall of the pouch 10, such as the front wall 14 of this example. The valve 20 is preferably welded in an aperture formed in the panel during the flexible pouch forming process. The valve 20 functions to exhaust gas, such as steam, formed within the package while cooking. The valve may also be operable to respire gas formed in the package for other reasons, such as gas formed by decaying food or during freezing or the like. The valve remains tightly closed, until pressure from the gas, such as steam, reaches a predetermined pressure value. An example of a predetermined pressure is approximately 3 mbar. The valve opens and remains open, to release the gas from the package in a controlled manner.

Various types of valves are contemplated. For example, a tape may be used to cover a hole in the panel. Alternatively, a pressure relief device, such as that manufactured by WIPF of Volketswll, Switzerland, Model Number W009, may be utilized. Another example of a valve is disclosed in commonly assigned U.S. patent application Ser. Nos. 10/228,430 and 10/967,547 and PCT Patent Application No. PCT/US2004/34361.

The valve is completely enclosed by a frangible seal 25 formed in the walls of the pouch. The frangible seal 25 is designed to burst when subjected to a predetermined frangible seal bursting pressure. The frangible seal 25 advantageously isolates the valve 20 from the contents of the pouch. The valve 20 and frangible seal 25 are preferably positioned so as not to interfere with filling or sealing of the pouch 10. The frangible seal 25 is automatically broken when the pressure in the pouch 10 exceeds a predetermined value, such as occurring when the pouch 10 is heated above a predetermined temperature. In one example, the frangible seal is broken due to the pressure buildup of steam within the pouch, thus allowing the steam to escape through the valve. In another example, the pressure can be increased by manipulating the pouch in order to break the frangible seal.

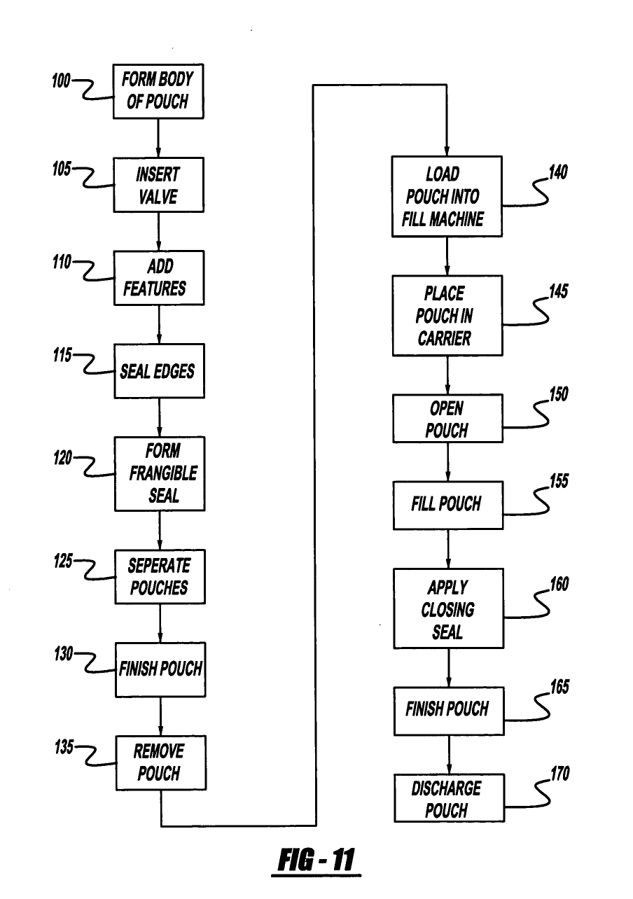

In the example shown in FIGS. 9 and 10, the frangible seal 25 has a “V” shape, although other shapes are contemplated. The seal 25 of this example is preferably positioned so that the side seam serves to enclose the open end of the “V” shaped seal. Other shapes for the frangible seal 25 are contemplated, such as an “L-shape”, or a circle, or a square as shown in FIG. 1, or the like.

It should be appreciated that the pouch 10 may include other components or features, as is known in the art. For example, the flexible pouch 10 may advantageously include a guide pocket 27 formed in a panel or wall of the pouch 10 prior to filling and sealing, to facilitate the separation of the front and rear panels prior to the filling of the pouch 10. An example of a pouch with a guide pocket is disclosed in commonly assigned U.S. patent application Ser. No. 10/310,221.

Another example of a component or feature is an opening means 26 for accessing the contents of the pouch. Various types of opening means are known in the art for this purpose. An example of an opening means 26 for accessing the contents or dispensing the contents from the pouch 10 is a cap secured to a fitment. It should be appreciated that the fitment is usually applied prior to filling the pouch. Another example of an opening means 26 is a straw-pierceable portion for receiving a straw. Still another example of an opening means is a resealable fitment, such as a zipper that is sold under the name TopTite™. A further example of an opening means 26 is a tear-off portion. The tear-off portion usually has an integral tear notch 34 for initiating the tearing. Still a further example of an opening means is a pull tab covering an opening in the pouch.

Still another example of a component or feature is an integrally formed label 44 having a barcode 46. The barcode enables information, such as cooking time and temperature, to be read by a scanner. For example, a microwave scanner may automatically read the label and automatically enter cooking time and temperature into a device, such as the microwave. Alternatively, the label may include a cooking temperature indicator 48, such as a strip of temperature-sensitive material which changes color upon reaching a predetermined temperature, so as to provide an indication that the food is properly heated.

A further example of a component or feature is a breathable patch 92 of microporous base film or oxygen transmission patch (OTR) incorporated into the pouch 10. As is understood, respiring biological materials, such as fresh-cut fruit and vegetables, consume oxygen and produce carbon dioxide at rates dependant upon temperature and the stage of their development. The storage capability of the product within the package depends on the relative and absolute concentrations of O₂ and CO₂ in the atmosphere surrounding the product, and on temperature. The incorporation of a breathable patch 92 in the package advantageously allows for venting of gas formed within the package and the intake of oxygen, in order to produce an atmosphere within the package having optimal O₂ and CO₂ concentrations for preserving the particular product. An example of such a patch 92 is produced by Landec Corporation, and disclosed in U.S. Pat. No. 6,376,032. The patch 92 is produced from a microporous film, which respires according to predetermined combinations of O₂ permeability and change in O₂ permeability, with temperature and ratio of CO₂ permeability to O₂ permeability. These films are typically supplied as rectangular or square patches having an adhesive strip extending around the periphery, and cover an opening in the wall of the pouch.

The respiration can be controlled by first die cutting a hole 96 in the wall of the pouch of a predetermined size, and affixing the breathable patch 92 over the hole. Because different food products, such as fruits, vegetables and meats, have different rates of decomposition, the amount of gas permeability varies depending on the product contained within the package. The hole size formed in the pouch or film may be varied in accordance with the food product contained within the package in order to control the rate of respiration.

In this example, a hot melt or pressure adhesive is used to bond the patch to the film. It should be appreciated that the adhesive should be of sufficient adhesive strength to resist pressure generated by steam during a heating operation, such as microwaving. For example, the adhesive may be applied to the patch in a pair of lines as shown at 94, in order to mount the patch 92 to the film or pouch. Steam produced during the heating of the product may eventually break down the first adhesive line or loosen the second adhesive line. The use of the two adhesive lines increases the adhesion of the patch 92 to the lid or pouch during heating.

In another example, an inner membrane of the valve 20 may be replaced with the breathable patch 92. In this way, the valve advantageously releases steam during heating and also respires during storage.

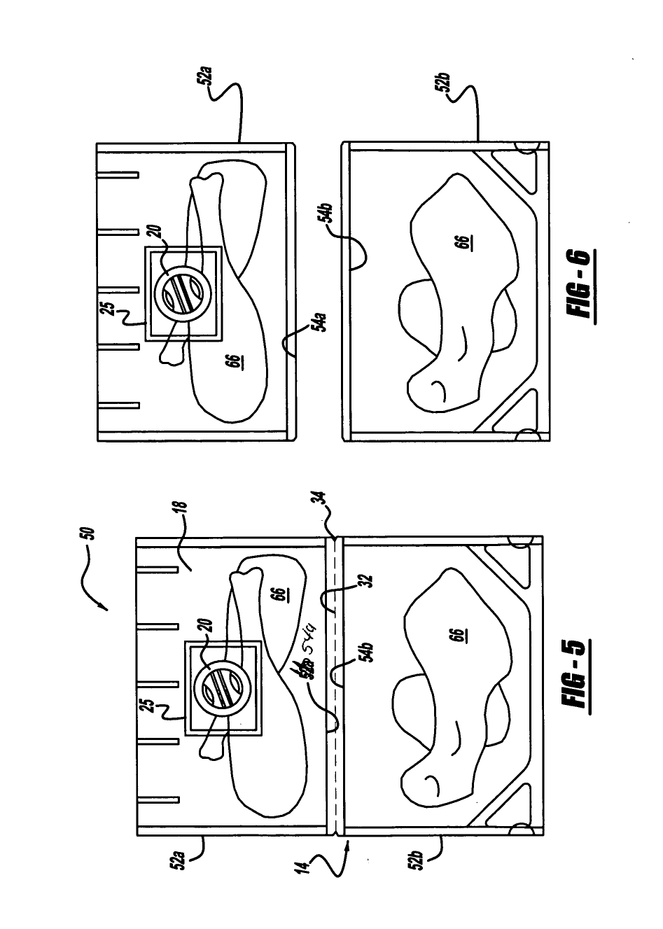

The pouch 10 may form one compartment for the product, as shown in FIGS. 9 and 10. As shown in FIGS. 1-6, the pouch 10 may include multiple discrete compartments. In the example shown in FIGS. 5 and 6, there are two compartments 52a, 52b. In this embodiment, seals 33 are formed on either side of a line of weakening shown at 32, to form the compartments 52a, 52b. It should be appreciated that each compartment may hold a unique product. For example, a first food portion, such as a salad, is filled into the lower compartment 52b of the pouch 50, and a seal 54 is formed on either side of the line of weakening 32. In this example the seal is a heat seal, although other types of seals could be utilized. Thus, the top of the lower portion is closed by a seal and a bottom of the upper portion is closed by a seal. A second food portion, such as chicken, is then filled into the upper compartment 52a and the upper edges of the upper compartment 52a are then sealed, as previously described. It should be appreciated that one or both of the upper compartment 52a or lower compartment 52b may also include a valve 20 surrounded by a frangible seal 25, to isolate the valve from the product.

In order to prepare the product, the upper compartment 52a is separated from the lower compartment by way of the tear notches 34 and line of weakening 32. By way of example, the upper compartment 52a may be heated, such as in using a microwave oven. After heating the upper compartment 52a of the pouch 50, the seal 52 at the upper edge of the lower compartment 52b is opened to form the tray and provide access to the contents contained therein, which in this example is a salad. In another example, a food product in the upper compartment 52a of the pouch 50 is heated, the bottom seal 54a of the upper compartment 52a is opened and the both products are served from the lower tray, for service as a meal. In another example, two different food products may be placed in the upper and lower compartments 52a, 52b respectively and a second valve is also mounted in the wall of the lower compartment 52b. The second valve may also be surrounded by a frangible seal 25. The upper compartment 52a and lower compartment 52b may be separated and heated separately. In this way, two food types which require different cooking times may be contained within the pouch. Both food portions may be served in the tray, as previously described.

It is contemplated that the pouch may undergo a secondary process after it is filled with the product. For example, the filled pouch may be frozen. Alternatively, the filled pouch may be pasteurized. Further, the pouch may incorporate any of the above-described features in any combination. The finished pouch may assume various shapes, such as cylindrical, cubical, conical or the like, as influenced by the type of product and intended usage of the pouch.

Referring to FIG. 11, a method for forming and filling the flexible pouch 10 having a frangible seal surrounding an integral valve, such as that described with respect to the previous figures, is illustrated. The method begins in block 100 with the step of forming the body of the pouch. Each pouch 10 has a predetermined shape, which in this example is a rectangle. The body of the pouch is formed from a roll of a preprinted laminate material, as previously described. In this example, the laminate material contains three layers.

One layer of the material is preferably preprinted with information or locating indicia (not shown), such as a registration mark. The registration marks are located on the material to denote an edge of a panel. The registration marks are read by an optical reading device (not shown), such as a scanner, to index the material in a predetermined position at the cutting station. The preprinted information may include labeling information that describes the product contained within the pouch. In this example, the layer of preprinted information is located on an outer layer of the material.

Various techniques may be utilized to form the body portion of the pouch, depending on the desired end shape of the pouch. The pouch may be formed from one sheet of material or two sheets. An example of a pouch forming machine is the Nishibe model number SBM500, SBM600 or SBM700. Preferably, several pouches are formed from one width of material. The material is removed from the roll, and may be cut into sections that are positioned to form the front panel and rear panel. The methodology advances to block 105.

In block 105, the valve 20 is inserted into one of the panels, such as the front wall panel. Various techniques are contemplated for insertion of the valve 20. For example, a valve aperture may be cut into the panel, and the valve is inserted into the aperture in the panel. The valve is welded to the panel, such as using a heat weld or and ultrasonic seal, to obtain an airtight seal around the valve. As previously described, the valve 20 provides for the venting of gas formed in the pouch 10, such as occurring by heating or cooling. The valve 20 is preferably placed in an upper corner of the pouch. It should be appreciated that an aperture 96 for the breathable patch 92 may be punctured at the same time as the valve aperture. The patch 92 is then applied over the patch aperture 96. The methodology advances to block 110.

In block 110, other features are added to the pouch 10. For example, a gusset or insert may be positioned between the sidewalls of the pouch. Alternatively, the gusset or pleat is formed in the panel using a folding operation. In another example of a pouch with one seam, a fold is formed along an edge in the sheet of material. An example of this type of pouch is disclosed in commonly assigned U.S. Patent Application Ser. No. 60/598,394, which is incorporated herein by reference.

An opening means 26, such as a fitment, may be included in this step. The opening means 26 may be located on the pouch 10 in a variety of locations, such as mounted on a bottom, or a top, or a side portion of the pouch. Various types of opening means are contemplated, as previously described. For example, if a reclosable pouch is desired, a zipper, such that manufactured by Zip Tight may be inserted. This type of zipper is easily opened from the outside, however, it provides resistance to pressure on the inside, and the greater the pressure on the inside, the tighter the zipper is sealed. The methodology advances to block 115.

In block 115, the edges of the panel are sealed together. It is contemplated that the side edges, a lower edge, or a center edge may be sealed, depending on the configuration of the pouch. Various techniques are known in the art for sealing the edges together. An example of a method for sealing the edges of the pouch is described in commonly assigned U.S. patent application Ser. No. 11/195,906, which is incorporated herein by reference. For example, a heat weld process includes the application of heat and compression in a two-step welding operation. Another type of seal is an ultrasonic seal. One edge of the pouch is left open, preferably designated as the upper edge 18, in order to fill the pouch. The methodology advances to block 120.

In block 120, a frangible seal 25 is formed in the pouch panel surrounding the valve 20. The frangible seal 25 prevents the food product from contaminating the valve 20, as previously described. The shape of the seal 25 is determinable based on the location of the valve 20 and the shape of the pouch 10. The seal 25 may be formed using an ultrasonic sealing process or a thermosealing process that includes in the application of heat, such as a heat weld. Preferably, the frangible seal 25 is formed at a low temperature and pressure so that the seal has a predetermined burst temperature or pressure. The burst temperature or pressure of the frangible seal 25 is generally determined by the type of food product contained therein.

The methodology advances to block 125 and the pouches 10 are separated into individual pouches along a cutting line. The material is cut into a pouch 10 using a known cutting apparatus, such as a laser or punch or the like. The cutting apparatus imparts a single cut in the material to separate the pouches. The length of the pouch 10 is controlled by the distance between the cuts.

Alternatively, two pouches are cut out at one time from the roll of material, by adding a double cut between two cuts, preferably in the center. Advantageously, forming two pouches during the cutting operation effectively doubles the assembly line speed. It should be appreciated that the upper edge or lower edge may be further trimmed, such as to accommodate a fitment, or obtain a predetermined final pouch shape. An example is described in commonly assigned U.S. Patent Application Ser. No. 60/695,394, which is incorporated herein by reference.

The methodology advances to block 130, and the pouch is finished. For example, a crease or guide pocket 24 may be formed in a top portion of each wall in a creasing operation in order to facilitate opening and filling the pouch. A forming technique, such as stamping, may be utilized. Another example of a forming technique is the use of heated tubes that thermoform a crease 24 in each wall. An example of a method of forming a crease in a wall to facilitate opening the pouch is disclosed in commonly assigned patent application Ser. No. 10/310,221, which is incorporated herein by reference.

The methodology advances to block 135, and the pouches 10 are loaded into a carrier that aligns the pouches in an upright position for transport to a filling machine. The methodology advances to block 140.

In block 140 the carriers containing the pouches are loaded onto a fill machine. Advantageously, the fill machine can be integral with the pouch forming machine, or a separate fill machine. This portability increases the flexibility of the pouch and may result in a manufacturing cost savings. An example is described in commonly assigned U.S. Pat. No. 6,837,535, which is incorporated herein by reference.

In block 145, the pre-made pouch 10 is then unloaded from the magazine and placed into a holder for moving the pouch between stations. An example of a holder is a cup-shaped member, as disclosed in commonly assigned U.S. patent application Ser. No. 10/336,601, which is incorporated herein by reference. Alternatively, the pouch 10 may be held with grippers (not shown) as is known in the art. The methodology advances to block 150.

In block 150, the pouch 10 is opened in an opening operation. Various techniques are conventionally known in the art for opening the pouch 10. For example, the guide pocket 27 formed by the crease in the front wall panel 14 and rear wall panel 22 facilitates opening of the pouch. A nozzle (not shown) may be mechanically lowered into the guide pocket 24 to direct a stream of compressed gas into the guide pocket 24, to force the walls of the pouch 10 away from each other. An example of a gas is carbon dioxide or nitrogen. The blowing station may include a manifold (not shown), with a hood extending over the top of the upper edges 18 of the pouch 10. The hood is placed over the pouch 10 to assist in maintaining the air pressure in the pouch 10. The supply of pressurized gas is directed through the aperture to form a plurality of jets of pressurized gas or air. The jets are directed downwardly at the diamond-shaped openings formed at the upper edges 18 to assist in overcoming the surface tension of the pouch and assist in separation of the walls 14, 22. A diving rod (not shown) may then be used to make sure the pouch 10 is fully opened. The methodology advances to block 155.

In block 155, the pouch 10 is filled with the prepared product in a filling operation. For example, a fill tube is lowered into the opened pouch 10 and the product is dispensed into the open pouch 10, as shown at 98. The product is preferably dispensed at a predetermined temperature. The temperature may be dependent on the type of product. In the case of larger pouches or multi-compartment pouches, it may be necessary to move the pouches to a second fill station to complete the filling of the pouch. It should be appreciated that if the pouch contains more that one section for different food products, each food product is dispensed into the corresponding section.

The pouches 10 may be moved to a station where any oxygen in the pouch residing above the product is removed, if necessary. This can be accomplished such as by providing a hood or diving nozzle, whereby the oxygen is either evacuated or displaced with carbon dioxide or nitrogen. A diving nozzle may be used to inject the gas.

If the product is naturally carbonated, such as beer or soda or the like, the pouch is preferably filled while immersed in a nitrogen atmosphere. If the product is not naturally carbonated, it may be immersed in a carbonator to introduce carbon dioxide into the product, such as carbonator or the like. For example, carbon dioxide is introduced into a water or juice product to provide a carbonated beverage. The product may contain a mixture of up to four volumes of carbon dioxide. It should be appreciated that the carbon dioxide masks any undesirable taste from ketones or other solvents released during the sealing process. The carbon dioxide also increases the pressure within the product so that the walls of the pouch are rigid after the top is sealed. The methodology advances to block 160. The product is preferably filled at a temperature ranging from 29° F. to ambient.

In block 160, the upper edge 16 of the pouch is closed by applying a closing seal 42. In this example, the pouch is closed by sealing the open edges together using a heat weld, or an ultrasonic seal or an ultra pulse seal or the like. If the pouch holds a carbonated beverage, the pouch may be sealed as described in commonly owned PCT Patent Application No. PCT/US03/034396 which is incorporated herein by reference. If the pouch is a multi-compartment pouch, the other compartments are also sealed using a closing seal 42.

In block 165, the filled pouch 10 is finished in a finishing operation. For example, the filled pouch may be cooled using a conventionally known cooling technique. The edges may be trimmed so that the pouch has a predetermined shape. The methodology advances to block 170.

In block 170, the filled pouch 10 is discharged from the machine. For example, the pouches are moved to a discharge station where the receptacles are moved from the arm of the turret outwardly onto the conveyor. The receptacles are then moved by the conveyor under robotic arms having grippers which are then lowered to grab the pouch 10 and lift the pouch 10 from the receptacles. The receptacles are then moved by the conveyor through a rinsing station and returned to the other side of the turret for use. The pouches 10 are placed by the grippers into cartons. At this point, the filled pouch is available for distribution. Alternatively, the filled pouch 10 may be placed onto another conveyor belt for additional processing, such as tunnel pasteurization for shelf stabilization, or freezing. In use, the unopened pouch may be heated and then separated into compartments, and each compartment is opened for accessing the contents contained therein.

It should be appreciated that the methodology may include other steps, such as an upstream oxygen purging station, a downstream oxygen purging station, pasteurization, or the like. In addition, a manufacturing station may perform one or a plurality of operations, to enhance the efficiency of the methodology and apparatus. It is also contemplated that the order of implementing the steps may vary to facilitate the manufacturing process.

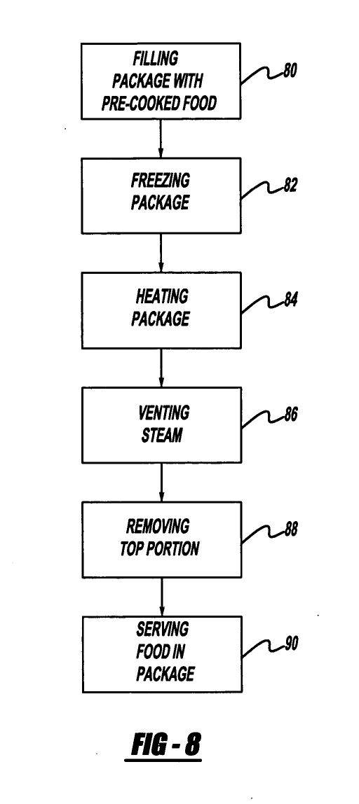

As shown in FIG. 7, another embodiment of a package 60 is illustrated. This package includes a lower portion that is a tray 62, and a removable upper portion that is a heat sealable/peelable film cover 64. The film cover 64 includes a vent 20, as previously described. The film cover may also include a breathable patch 92, as previously described. The tray is filled with a portion of food (not shown). The tray 62 is preferably produced of a clear plastic such as cast polypropylene. The tray 62 has a bottom 66 and a side 70 having a top edge 72. The tray should remain stable to 72° Celsius. The tray 62 may have a variety of shapes, such as an oval shape. The tray may include integrally formed ribs 74 in the side 70 to provide strength to the tray. The tray may include an integrally formed handle 76 at each end to facilitate use of the tray 62.

The cover 64 is formed from a laminate material. For example, the laminate material includes a polyester layer, a polypropylene layer, and an adhesive layer. The polyester layer of this example has a thickness of 12.0 micrometers and a weight of 16.8 grams/m². The polypropylene layer of this example has a thickness of 90.0 micrometers and a weight of 81.0 grams/m². The adhesive layer of this example has a thickness of 2.5 micrometers and a weight of 2.5 grams/m². The film laminate preferably has a low oxygen permeability and water vapor permeability. In this example, the sealing medium of the adhesive layer has a melting point of 165° Celsius and a sealing range of 180°-230° Celsius, depending upon sealing time and pressure. An example of an adhesive layer is a mixture of a cast polypropylene and polyethylene. The film should be able to withstand a minimum amount of heat, such as a temperature of 120° Celsius. An example of this type of film is available from WIPF of Volketswll, Switzerland.

The film is supplied as a web. The web is unrolled and apertures are formed in the web at predetermined spaced apart locations. The vent device 20 is heat welded to the film in the aperture formed in the web. The breathable patch 92 is applied to the cover 64 as previously described. The portion of food 12 is filled into the tray 62 and the trays 62 are then delivered by a conveyor to a station where the web of film which is then sealed on the edge 72 of the tray and cut to the shape of the tray 62. After heating, the cover may be peeled from the tray and the food is served in the tray.

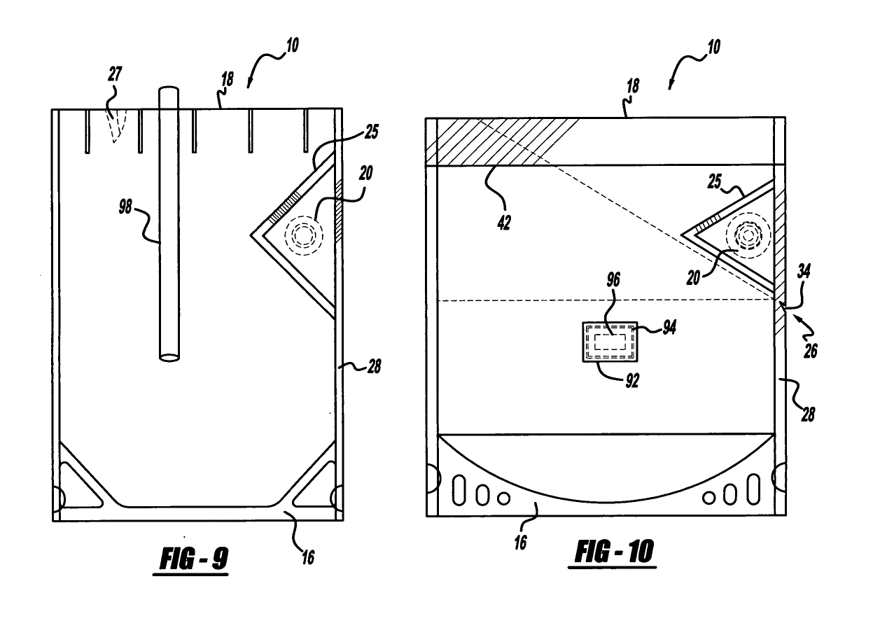

Referring to FIG. 8, a method of use of the flexible pouch is illustrated. In this example, a portion of precooked food having a moisture content which is generally 20% is dispensed into a package. The food portion can be a single food item or can be a dish prepared to a recipe. The precooking prevents rapid decomposition of the food. Thus, food which has been at least partially precooked will have a shelf life of up to seventeen days whereas raw food will have a shelf life of approximately seven days. In the precooked or blanched state, the food is cooked until it reaches a temperature of 125° Celsius. Satisfactory temperature ranges for partially cooked food are set forth as follows:

| | Temperature |
|---|---|
| Food | Celsius |
| Chicken | 125 |
| Beef | 130 |
| Fish | 110 |
| Pork | 125 |
| Green beans | 105 |
| Carrots | 105 |
| Broccoli | 100 |

Examples of satisfactory recipes are set forth below.

### EXAMPLE 1

Seared Chicken and Rice with Vegetables

| AMOUNT | INGREDIENT | NOTES |
|---|---|---|
| 135 g. | 90% cooked rice | Parboiled long grain rice |
| 40 g. | Blanched broccoli florets, | Blanched in salted water |
| | small | |
| 25 g. | ¼ inch sliced and seared | Seared in canola oil |
| | button mushrooms | |
| 25 g. | ¼ inch sliced, blanched | Blanched in salted water |
| | and half moon cut carrots | |
| 10 g. | Prepared chicken stock | Prepared from chicken base |
| | | paste and water |
| 120 g. | Seared and ¼ inch slight | Seasoned with kosher salt and |
| | bias-sliced chicken breast | fresh ground black pepper; |
| | | seared quickly on both sides. |
| | | Trimmed of all fat and cartilage. |
| | | Seared in canola oil |
| 355 g. | | |

| | METHOD |
|---|---|
| 1. | Place rice, vegetables and chicken stock in base of container |
| 2. | Place chicken, slightly shingled, in one line across top of rice and |
| | vegetables |
| 3. | Place top on container and seal |
| 4. | Microwave at 800 watts for 4 minutes or until chicken is just cooked |
| | through |

### EXAMPLE 2

Penne Pasta Primavera with Seared Chicken

| AMOUNT | INGREDIENT | NOTES |
|---|---|---|
| 125 g. | 90% cooked penne or | Cooked in salted water. Real |
| | farfalle pasta | Torino brand, 100% durum |
| | | semolina |
| 30 g. | Blanched broccoli florets, | Blanched in salted water |
| | small | |
| 25 g. | ¼ inch sliced and seared | Seared in canola oil |
| | button mushrooms | |
| 25 g. | ¼ inch sliced, blanched | Blanched in salted water |
| | and half moon cut carrots | |
| 20 g. | Frozen peas | |
| 60 g. | Prepared alfredo sauce | Digiorno brand |
| 10 g. | Prepared chicken stock | Prepared from chicken base |
| | | paste and water |
| 100 g. | Seared and ¼ inch | Seasoned with kosher salt and |
| | straight sliced chicken | fresh ground black pepper; |
| | breast | seared quickly on both sides. |
| | | Trimmed of all fat and cartilage. |
| | | Seared in canola oil |
| 395 g. | | |

| | METHOD |
|---|---|
| 1. | Combine pasta with vegetables and alfredo sauce and toss to coat |
| | well. Place entire contents in base of container |
| 2. | Top with chicken slices in a single layer |
| 3. | Place top on container and seal |
| 4. | Microwave at 800 watts for 3 minutes 30 seconds, or until chicken is |
| | just cooked through |

Once the food has been precooked, it is available for packaging. The total volume of the food must not exceed 500 grams for a container having a volume of 700 grams. It should be appreciated that the food in the package may be processed, such as in a freezing step 82, where the food in the package is then flash frozen and stored until meal time. In this example, the valve device may be of the type which respires during the freezing. If desired, the valve may be covered with a seal which is removed before cooking.

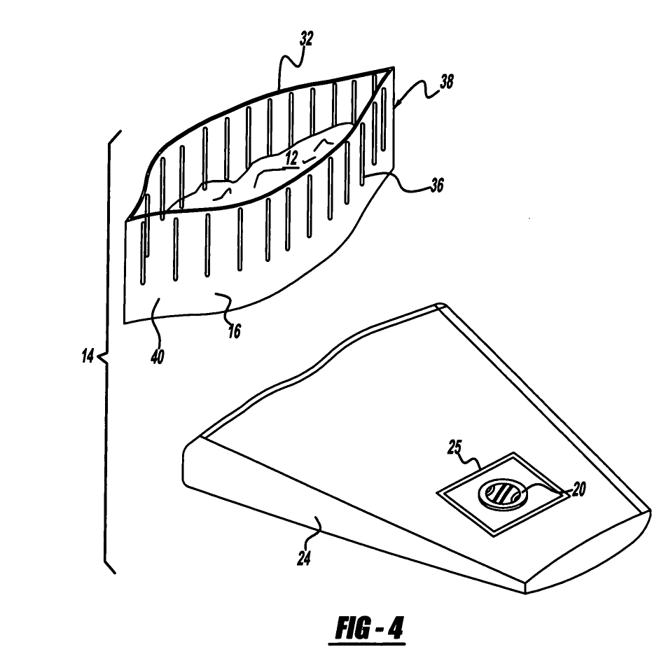

In step 84, the filled pouch may be then heated as required for the recipe, such as using a microwave oven at a predetermined power level and time. In step 86, as the food portion is being heated, steam is vented from the package. The valve device 20 opens when the pressure within the pouch exceeds a predetermined pressure, such as 3 mbar and remains fully open throughout the heating process. In step 88, the user separates the pouch compartments along the line of weakening. The user opens up each compartment to access the food product contained therein. In step 90, the user serves the product from the package. For example, the product can be served directly from the package. The product can be placed in the bowl 38 formed from the lower compartment, as shown in FIG. 4. The products in each compartment may be mixed together, or kept separate.

The present invention has been described in an illustrative manner. It is to be understood that the terminology which has been used is intended to be in the nature of words of description rather than of limitation.

Many modifications and variations of the present invention are possible in light of the above teachings. Therefore, the present invention may be practiced other than as specifically described.

1. A flexible pouch having an integral valve for both packaging and preparing a product comprising:
a panel having an upper edge, an opposed lower edge, and a side edge extending therebetween said upper and lower edges;
a valve disposed in said panel, wherein said valve is a one-way valve for releasing a gas from the pouch at a predetermined gas release pressure; and
a frangible seal enclosing said valve to isolate said valve from the product contained in the flexible pouch, wherein said frangible seal is intact when a pressure within the flexible pouch is less that a predetermined frangible seal bursting pressure, and said frangible seal is broken when the pressure within the flexible pouch is greater than the predetermined frangible seal bursting pressure to release the gas from the pouch through said valve.

2. The flexible pouch as set forth in claim 1 wherein said panel includes a front wall and a back wall.

3. The flexible pouch as set forth in claim 1 further including an opening means for dispensing the product from the pouch.

4. The flexible pouch as set forth in claim 3 wherein said opening means is a tear-off strip defined by a line of weakening extending between two edges of the pouch.

5. The flexible pouch of claim 1 wherein said valve is positioned adjacent said side edge of said panel.

6. The flexible pouch of claim 5 wherein said frangible seal has a “V” shape, and said frangible seal is oriented to enclose said valve between said frangible seal and said side edge.

7. The flexible pouch of claim 1 further comprising a breathable patch covering an opening in said panel, wherein said breathable patch includes a one-way valve for respiring a gas accumulating in the flexible pouch from the natural decay of the product contained within the pouch.

8. The flexible pouch of claim 1 further comprising a seal separating the flexible pouch into an upper compartment and a lower compartment.

9. The flexible pouch of claim 1 further comprising a second valve disposed in said wall of said lower compartment, wherein said second valve is a one-way valve for releasing a gas from the lower compartment at a predetermined gas release pressure.

10. The flexible pouch of claim 1 further comprising a breathable patch covering an opening in said panel of said lower compartment, wherein said breathable patch includes a one-way valve for respiring an accumulating gas in the lower compartment from the natural decay of the product contained within the lower compartment.

11. A flexible pouch having an integral valve for both packaging a product and serving the product comprising:
a panel having an upper edge, an opposed lower edge, and a side edge extending therebetween said upper and lower edges;
a valve disposed in said panel, wherein said valve is a one-way valve for releasing a gas from the pouch at a predetermined gas release pressure;
a breathable patch covering an opening in said panel, wherein said breathable patch includes a one-way valve for respiring an accumulated gas in the flexible pouch from the natural decay of the product contained within the pouch; and
a frangible seal enclosing said valve to isolate said valve from the product contained in the flexible pouch, wherein said frangible seal is intact when a pressure within the flexible pouch is less that a predetermined frangible seal bursting pressure, and said frangible seal is broken when the pressure within the flexible pouch is greater than the predetermined frangible seal bursting pressure to release the gas from the pouch through said valve.

12. The flexible pouch as set forth in claim 11 wherein said panel includes a front wall and a back wall.

13. The flexible pouch as set forth in claim 11 further including an opening means for dispensing the product from the pouch.

14. The flexible pouch as set forth in claim 13 wherein said opening means is a tear-off strip defined by a line of weakening extending between two edges of the pouch.

15. The flexible pouch of claim 11 wherein said valve is positioned adjacent said side edge of said panel.

16. The flexible pouch of claim 15 wherein said frangible seal has a “V” shape, and said frangible seal is oriented to enclose said valve between said frangible seal and said side edge.

17. The flexible pouch of claim 11 further comprising a seal separating the flexible pouch into an upper compartment and a detachable lower compartment.

18. The flexible pouch of claim 17 further comprising a second valve disposed in said wall of said lower compartment, wherein said second valve is a one-way valve for releasing a gas from the lower compartment at a predetermined gas release pressure.

19. The flexible pouch of claim 17, wherein a side wall of said lower compartment includes ribs to provide rigidity to said side wall.

20. A method of forming and filling a flexible pouch for both packaging and preparing a product contained therein, said method comprising the steps of:
forming a pouch from a panel having an upper edge, a lower edge opposite the upper edge, and a side edge extending therebetween the upper and lower edges;
inserting a one-way valve in the panel, wherein the valve relieves a pressure within the pouch;
forming a frangible seal around the valve that isolates the product from the valve when the frangible seal is intact, wherein the frangible seal is broken when a pressure within the pouch exceeds a predetermined frangible seal bursting pressure;
sealing the side and lower edges of the pouch;
opening the pouch;
filling the pouch with the product;
sealing the upper edge of the filled pouch; and
increasing the pressure in the pouch until the pressure exceeds the predetermined frangible seal bursting pressure and the frangible seal breaks, to release the gas from the pouch through the valve.

21. The method as set forth in claim 20 further including the steps inserting a breathable patch in an opening in the panel, wherein the breathable patch includes a one-way valve for respiring an accumulated gas in the flexible pouch from the natural decay of the product contained within the pouch.

22. The method as set forth in claim 21 further including the steps of:
separating an upper compartment of the pouch from a lower compartment of the pouch along a line of weakening; and
serving the product in the lower compartment of the pouch.
